(19) United States
(12) Patent Application Publication
(10) Pub. No.: US 2024/0403948 A1
(43) Pub. Date: Dec. 5, 2024

(54) SYSTEMS AND METHODS FOR ALLOWING CONSUMERS TO USE LEASE-PURCHASE PLANS TO OBTAIN PRODUCTS FROM THIRD-PARTY MERCHANTS

(71) Applicant: KATAPULT GROUP, INC., NEW YORK, NY (US)

(72) Inventors: CHANDAN CHOPRA, Fort Worth, TX (US); NADIM RAHMAN, Melissa, TX (US); FALLON MCNEILL, Virginia Beach, VA (US); BEN HAMMER, Manchester, NH (US); AMIT VERMA, Frisco, TX (US); MOHIT PARASHAR, Bhopal (IN); SHUBHAM YADAV, Noida (IN); ARJUN NAIR, Thane (IN)

(21) Appl. No.: 18/680,138

(22) Filed: May 31, 2024

Related U.S. Application Data
(60) Provisional application No. 63/470,368, filed on Jun. 1, 2023.

(51) Int. Cl. G06Q 30/0645; G06Q 20/12; G06Q 20/34

(52) U.S. Cl. CPC G06Q 30/0645; G06Q 20/12; G06Q 20/351

(57) ABSTRACT

The lease-purchase system gives consumers access to numerous products at merchants through a flexible lease-purchase transaction. The lease-purchase system allows merchants to grow their customer bases and allows them to move inventory through another consumer payment method. A parsing engine is utilized to automatically determine which merchant items are eligible to transaction via the lease system. At any time throughout the life of the lease-purchase transaction, the consumer can purchase the leased product or return it.

### CROSS-REFERENCE TO RELATED APPLICATIONS

This application claims priority to U.S. Provisional Application Ser. No. 63/470,368, filed Jun. 1, 2023, the entire contents of which are hereby incorporated by reference in their entirety.

### FIELD OF THE INVENTION

The present invention relates to offering lease-purchase plans to consumers for virtual or in-store merchants.

### BACKGROUND

When consumers purchase a product with a credit card online or in person, the full amount of the purchase is charged to the credit card and the consumer is responsible for paying off the credit card balance all at once or in installments. However, the average credit card interest rate is above 20% which can greatly increase the cost of the purchased item if it is paid off in installments. Certain third-party consumer finance companies currently allow the consumer to divide the purchase amount into a number of monthly installments that are charged to a credit card. However, the consumer is still responsible for paying the credit card and related interest which can quickly accrue, especially when only the minimum required monthly payment is being made.

As a payment option, lease-purchase transactions offer consumers the ability to immediately obtain the goods they need while offering the consumer reasonable payment amounts along with the flexibility to own the item outright at any time or return the item to the lease-purchase company. And unlike traditional forms of credit such as credit cards, lease-purchase plans generally do not require the consumer to have substantial assets or a stellar credit score. Unfortunately, the lease-purchase form of payment is not available throughout the United States consumer retail marketplace due to certain technological limitations. The invention provides a technological answer to the current limitations.

A need exists for technology that will allow for the use of a lease-purchase transaction payment methods throughout the United States consumer retail industry and on a wider variety of products from merchants and that is also more user-friendly. Further, the lease-purchase system should be able to offer more favorable repayment terms than credit cards together with purchase options. The lease-purchase system should also be easily integrated into existing merchant platforms and be capable of automatically determining which products from each merchant qualify for leasing.

### SUMMARY

The lease-purchase system of the present invention utilizes a long short-term memory (LSTM) model, designed to handle long-term dependencies in text data, for predicting the leasability of products based on their descriptions. The lease-purchase system allows for collecting, preparing, and preprocessing large datasets of product information from various merchants, ensuring the data is suitable for training the LSTM model.

In some embodiments, the LSTM model utilizes a four-layer model architecture comprising an Embedding layer, LSTM layer, Dense layer, and Output layer with SoftMax activation to accurately predict the leasability of products and their respective categories and subcategories.

The lease-purchase system may comprise a color list module for blacklisting and whitelisting system to override incorrect leasability predictions, improving the customer checkout experience while addressing business and legal compliance needs. The lease-purchase system also comprises a retraining module for regularly retraining the LSTM model using newly collected data to ensure continued accuracy and adaptability in a constantly changing e-commerce environment.

### BRIEF DESCRIPTION OF THE DRAWINGS

FIG. 1 depicts a system diagram of lease-purchase system according to an embodiment of the invention.

FIG. 2 depicts a flowchart showing the steps utilized by a consumer to lease a product using the lease-purchase system.

FIG. 3 depicts the steps used to train the LSTM model.

FIG. 4 depicts the steps used to retrain the LSTM model.

FIG. 5 depicts the steps used to perform a merchant check using the lease-purchase system.

FIG. 6A depicts the model architecture of the LSTM model according to an embodiment of the invention.

FIG. 6B depicts the steps used for prediction by the LSTM model of FIG. 6A.

FIG. 7 depicts an alternate embodiment of model architecture of the LSTM model.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

The embodiments disclosed herein are for the purpose of providing a description of the present subject matter, and it is understood that the subject matter may be embodied in various other forms and combinations not shown in detail. Therefore, specific embodiments and features disclosed herein are not to be interpreted as limiting the subject matter as defined in the accompanying claims.

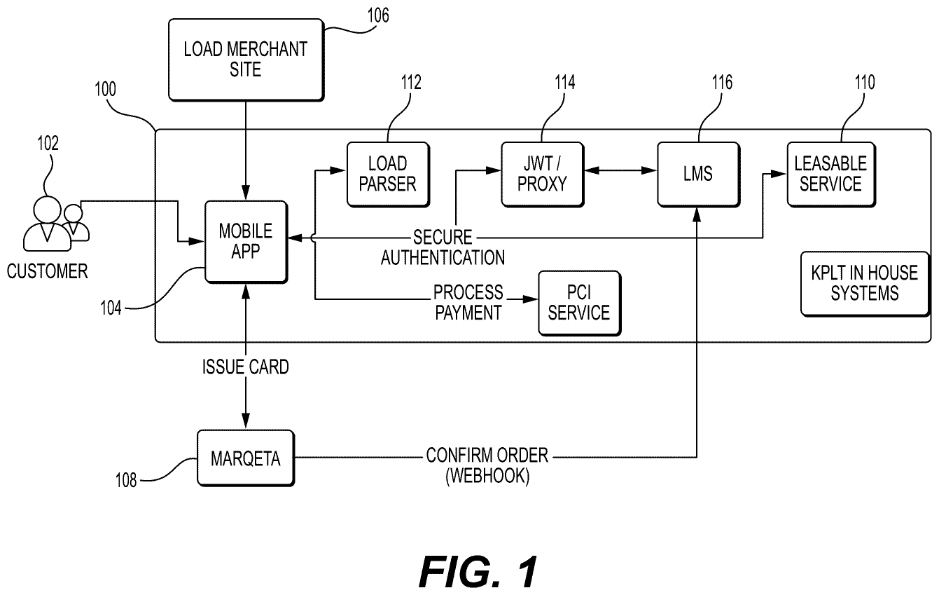

Referring first to FIG. 1, depicted is a system diagram of lease-purchase system 100 and its network environment. As shown, consumers 102 interface with lease-purchase system 100 through a mobile application 104. The mobile application 104 may be a smart phone application or a website visited by consumer 102.

The mobile application 104 also interfaces with external merchant websites 106 and virtual credit card issuers 108. The mobile application 104 is in secure communication with leasable service 110. For example, secure authentication between mobile application 104 and leasable service 110 may be protected by JWT (JSON web token) authentication service 114. Leasable services 110 is primarily responsible for determining which items are leasable at each merchant website 106 and which items are not leasable.

Load parser 112 is primarily responsible for initially parsing merchant websites 106 to extract product information used in determining which items are leasable. The process utilized by load parser 112 to process merchant websites 106 will be described later.

Lease management system (LMS) 116 tracks items browsed by the consumer 102 and allows them to be added to the virtual shopping cart of the consumer. After an order is confirmed, LMS 116 communicates with virtual credit card issuer 108 which issues the consumer 102 a virtual credit card to be used in checking out on merchant website 106. LMS 116 also determines lease terms for each transaction and is responsible for receiving and processing lease payments from consumers 102. For example, the leas

### Lease-Purchase Process

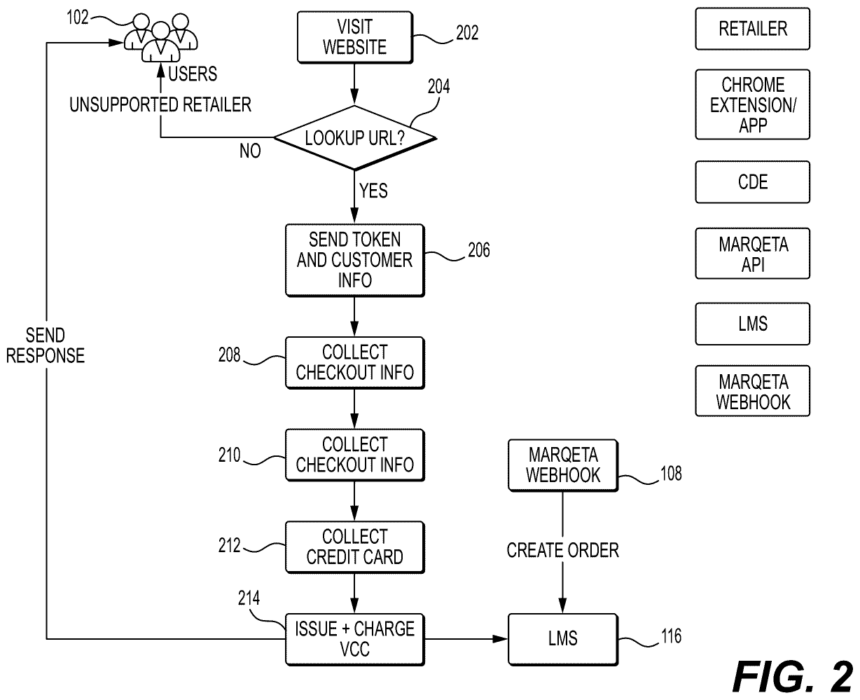

FIG. 2 depicts a flowchart showing the primary steps utilized by consumer 102 to lease a product using the lease-purchase system 100 of the present invention. First, consumers 102 visit the merchant website 106 at which they wish to make a transaction in step 202. The lease-purchase system 100 then determines if the merchant is a supported retailer in step 204. If the merchant is supported, a token is sent to the consumer in step 206. The consumer adds items to their shopping cart that the user wishes to obtain in step 208. When the consumer is finished shopping, they may choose a checkout option associated with the lease-purchase system in step 208.

The consumer then applies for a lease-purchase transaction through the lease-purchase system 100 and an instant decision is sent to the consumer 102. After the checkout option is selected, the shopping cart information is pushed from merchant website 106 to the lease-purchase system 100 to determine if the product(s) qualifies for a lease-purchase transaction in step 210. If the merchant is verified and the product(s) in the shopping cart qualify, the consumer 102 is redirected to a mobile application 104 for collecting consumer information for the lease-purchase in step 206. In some embodiments, the consumer may be redirected to a website (e.g., via a pop-up, plug-in, extension, or redirect) associated with the lease-purchase system. The consumer information may include, but is not limited to, full name, phone, SSN, email, billing address, and shipping address.

Credit and/or credit card information is then collected in step 212. The credit card information may include credit card number (e.g., number, expiration date, check code, etc.), billing address, and card holder name. The credit card information is used by LMS 116 to determine if a lease-purchase transaction for the consumer 102 should be issued in step 214.

The same credit card is also used to collect the initial origination fee for the lease, if any, which can vary. The collected credit card information is also used to set up the recurring payment plan for consumer 102 and is marked as the default card on file for future payments. The virtual credit card number is then issued by virtual credit card issuer 108.

The issuance of the virtual credit card number requires sending a request to the virtual credit card issuer 108 to issue a virtual card for the consumer 102. The virtual card is generated based on the checkout amount and is restricted into two phases:
Time window based restriction-if the virtual card is not used within a predetermined time period (e.g., 15 minutes), a background job will close it.
Merchant group based restriction-a virtual card issued for a specific type of merchant and cannot be used anywhere else (e.g., a virtual card issued for a first merchant cannot be used for a second merchant different than the first merchant. A virtual credit card issued for home improvement store 1 can be used in home improvement store 2 since both are home improvement stores (within the above mentioned 15 minute time window), but it cannot be used in an electronics retailer.

If the virtual card issue request is successful, a view card request is sent to the virtual credit card issuer 108. This allows the customer to be able to see the entire card number, expiration date and CVV of the issued virtual card which can then be used to pay the merchant(s) for the goods in step 214. When the virtual card is used, it does not lead to order settlement. Rather, the lease-purchase system 100 monitors the webhook of the virtual credit card issuer for confirmation of the issued card usage, and once the webhook is received, the lease/order is settled.

The virtual credit card is used to complete the transaction on the merchant website 106. A lease-purchase order is created in the LMS 116 to track payment from the consumer 102 and the initiation of the lease.

In a preferred embodiment, consumer 102 pays any fees directly to LMS 116 using the credit card information. However, at any point after lease initiation, the consumer 102 can update the debit or credit card on file through mobile application or other means such as by contacting a contact center, using a customer portal, interactive voice response system etc.

The consumer 102 may return the leased product(s) at any point during the terms of the lease (depending on conditions) to discontinue payments. In some embodiments, the consumer 102 may face a penalty or fee if the product is returned early (e.g., within two months). Generally, the lease terms will comprise a recurring payment amount, a payment time period, and conditions. For example, the conditions may include that the products must be returned in a certain condition or extra charges may apply. The conditions may also allow the consumer 102 to end the lease early by returning the product, causing payments to end. If user completes all lease payments, the consumer may own the product at the end of the lease or may be provided with terms to purchase the product (e.g., a one time lump sum payment).

### Model Training and Retraining

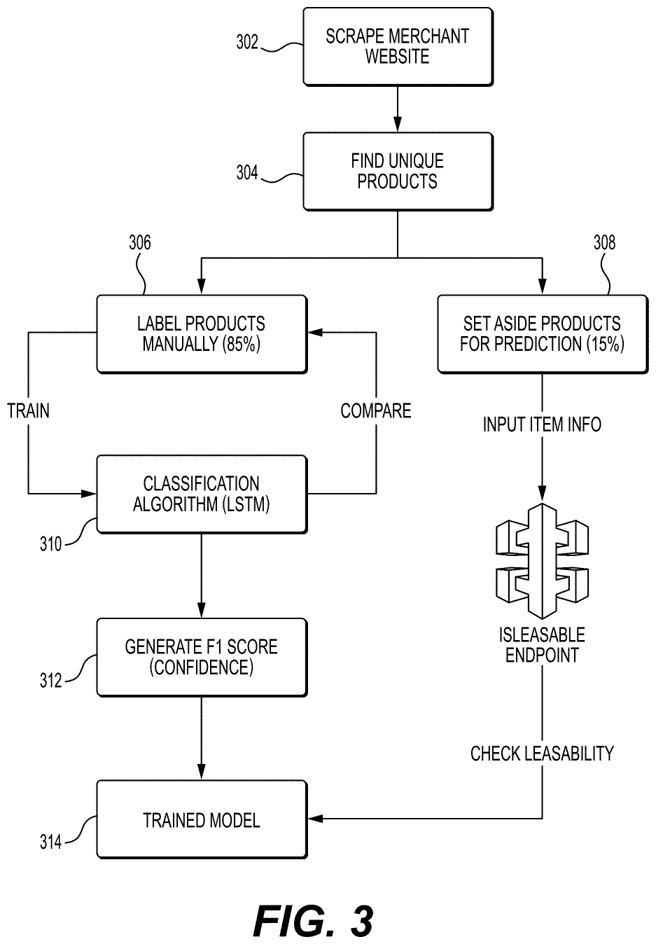

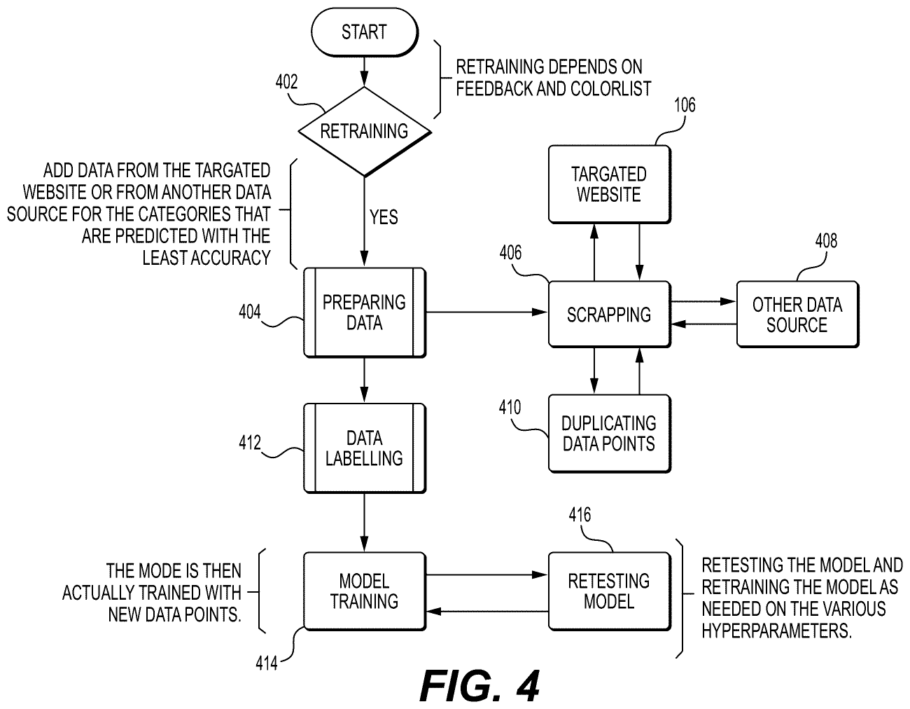

The LSTM model of the lease-purchase system 100 allows for the automatic determination of which products on a merchant website are leasable and which are not leasable. The LSTM model and training is primarily executed by the leasable service 110 as described in FIGS. 3 and 4. The LSTM model is trained as described in FIG. 4. First, data must be collected and prepared for training. This is accomplished by scraping product data from various merchant websites 106 including product URLs, descriptions, and categories in step 302 using load parser 112. The product data can be extracted from the product URLS, for example. The product data is used to identify unique products which may qualify for lease-purchase in step 304. The product data may be pre-processed by cleaning and tokenizing product titles. Products in the training set are manually assigned main categories (C1) in step 306 for training the LSTM model. The validation set is set aside for prediction in step 308. In a preferred embodiment, separate LSTM models are trained in step 310 for predicting main categories (C1), categories (C2), and subcategories (C3) using the product titles as input feature vectors. A F1 score is generated for each LSTM model in step 312. If the F1 score is acceptable (e.g., above a predetermined threshold), the products set aside in step 308 are categorized by the LSTM model in step 314.

The performance of the LSTM models is monitored on the validation set and fine-tunes the models as necessary. As new products are made available, the LSTM models are regularly retrained as depicted in FIG. 4. New products may be monitored by regularly parsing merchant websites using DOM observability.

The lease-purchase system 100 monitors accuracy of predictions over time. If the lease-purchase system 100 accuracy falls below a predetermined threshold, retraining 402 may be initiated. The accuracy may be determined based on factors such as color, exception, and category lists. First, the least accurate data from merchant websites is sampled and prepared for retraining in step 404. The load parser 112 then scrapes the target merchant websites 106 in step 406. The collected data is reconciled with other data sources like color, exception, or category lists in step 408 and is cleaned to eliminate any duplications in step 410.

The newly collected data is then labeled in step 412 and model trained in step 414. The updated LSTM model is then retested to determine accuracy in step 416. If the accuracy is too low, the LSTM model is again retrained based on determined hyperparameters (e.g., color, exception, and/or category list) from the retraining.

### List Implementation

The lease-purchase stem 100 generally maintains three kinds of lists as part of leasability determination as described below:
1. Color list: List of items which are always not leasable (e.g., consumable products like milk, eggs, printer paper)
2. Category list: List of categories that are always not leasable (e.g., grocery)
3. Exception list: List of keywords which are always not leasable due to business decisions or processes (e.g., water heater, drones, guns, ammunition)

For all three types of lists, an initial list is generated in coordination with the merchant website 106 operations, and legal teams. The lists are loaded and maintained in a database (e.g., database hosted in Dynamo DB). Data from the lists can be retrieved in real time from the database. In case of any additions to the lists, the operations team can report any item to be added to a list, and a technical support team can expand it by a database entry via an API. To speed up performance, all data from the lists may be cached for a much improved user experience.

### Merchant Check

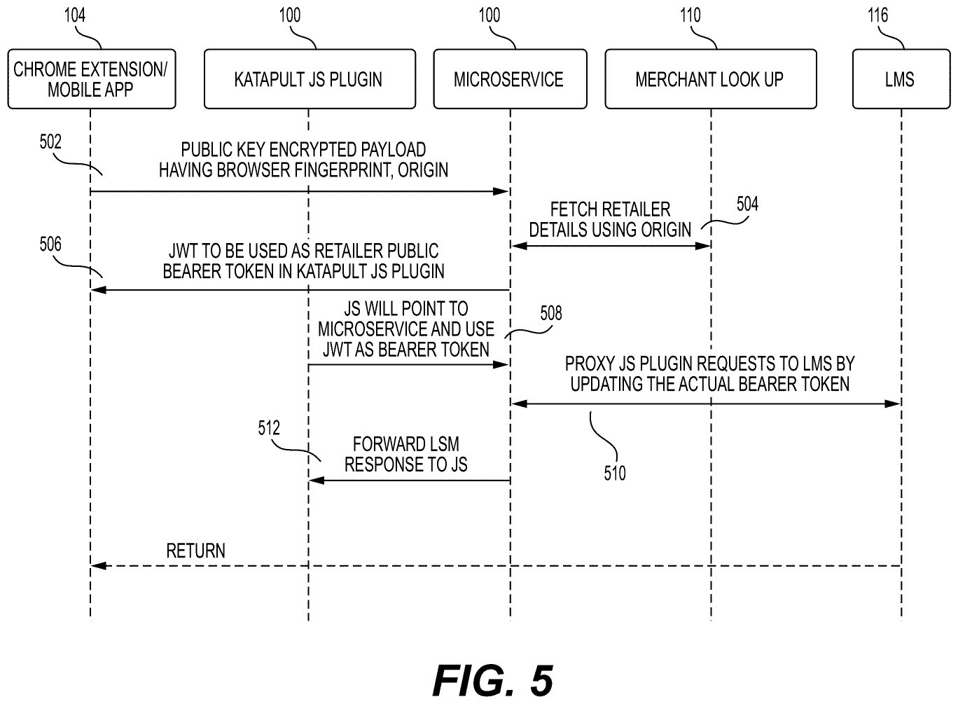

FIG. 5 depicts the steps used in performing a merchant check (steps 204 and steps 206 from FIG. 2) by lease-purchase system 100. Generally, a merchant check is the process of retrieving merchant-related information and a merchant public bearer token from the LMS 116 for further usage by mobile application 104 or a browser extension. As a result, the process requires a lookup API to obtain information about certain merchant websites 106, such as the public token, merchantDomParserFile location, etc. Merchant Lookup delivers an encrypted payload containing information such as origin, IP address, user agent, and other characteristics.

Merchant lookups are preferably performed via a JavaScript (JS) plugin request. To perform a merchant lookup, a public key encrypted payload including the browser fingerprint and origin is transmitted from the mobile application to lease-purchase system 100 in step 502. The merchant details are retrieved from leasable service 100 using the origin in step 504. A JWT token to be used as the public bearer token for future requests is retrieved by the mobile application 104 from JWT authentication service 114 in step 506. The JWT token will be modified in step 508 to point to the lease-purchase system 100 and use the JWT token as the bearer token in step 510. The response from LMS 116 is forwarded to the lease-purchase system 110 in step 512.

### LSTM Model Architecture

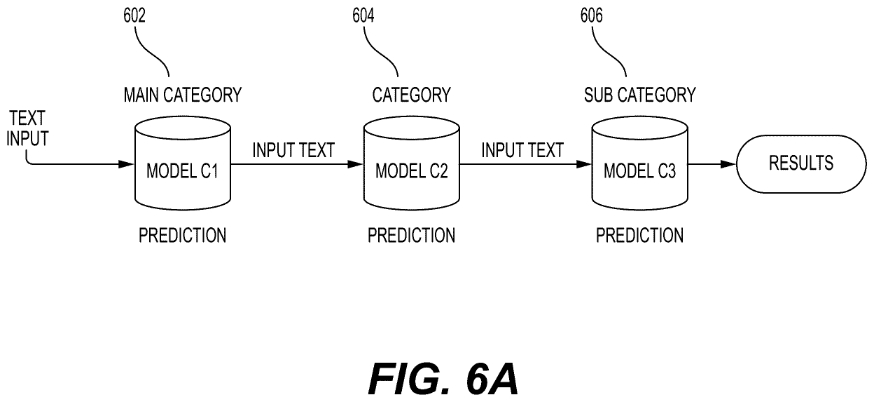

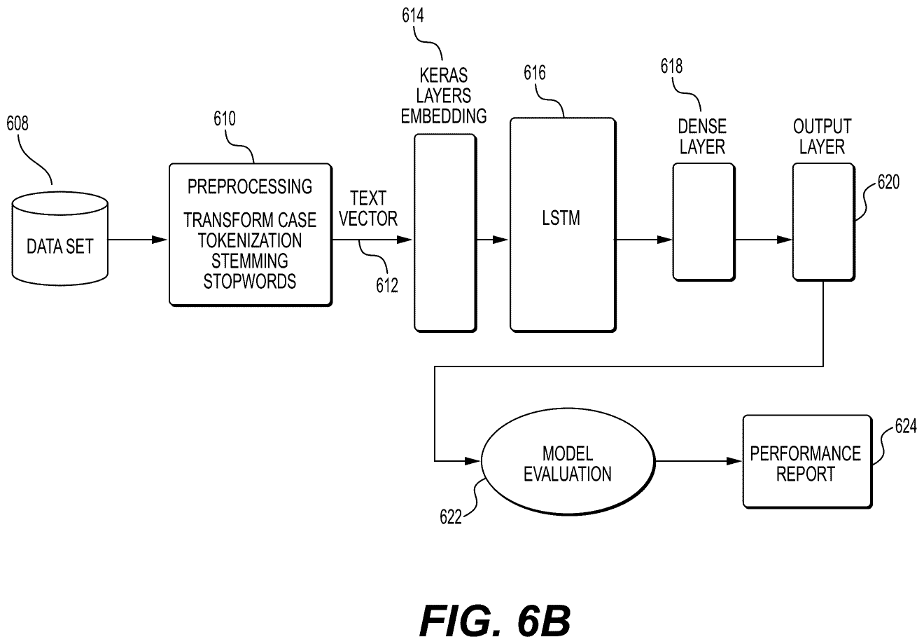

FIG. 6A depicts the model architecture of the LSTM. The model is trained on three broad sets of data, main category 602, category 604, and sub category 606 in a hierarchy. The predictions from each previous step are used as input for the next step (e.g., results from main category 602 training are used as the input for category 604 training). Only the result of the final prediction of sub category 606 are used as the output.

FIG. 6B depicts the process that is executed as part of the each steps of prediction for each of the three sets of data. First, data is scraped and cleaned from the merchant website 106 as previously described to form a dataset 608. The dataset 608 then goes through a sanitization process of stop words, case normalization, and stemming in step 610. This generates a text vector 612 that can be used for embedding. The embedding layer 614 generates a matrix of vectors that were derived from the tokens generated from the dataset in step 610. This step sets up the foundation to be able to train the model in order to start prediction.

The LSTM layer 616, under control of leasable service 110, handles long-term dependencies in text data and predict the leasability of products. In essence, the LSTM layer 616 is responsible for the classification of text from merchant websites 106 into leasability determination (leasable or non-leasable).

The Dense layer 618 applies Rectified Linear Unit (ReLU) activation to output from the LSTM layer 616. The Dense layer 618 allows models to be trained faster and thereby have better performance. The Output layer 620 uses SoftMax activation to predict a multinomial probability distribution for the main category 602, category 604, and subcategory 606 labels. The models are tested and the results are checked against expected results in step 622. A score is generated (F1 score) that acts as an indicator of accuracy. A report summarizing the score and accuracy results is then generated in step 624.

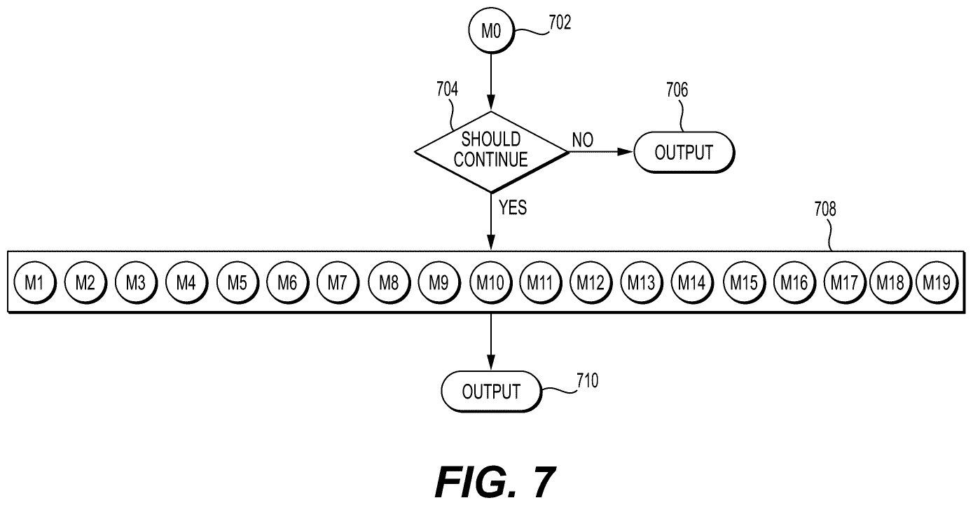

FIG. 7 depicts an alternate embodiment of model architecture of the LSTM. This model architecture utilizes a node-based design where each subcategory belongs to a single node instead of all subcategories belonging to the same node as depicted in FIG. 6A. This architecture allows adding or optimizing any new or existing categories without impacting accuracy of other categories. Further, this model architecture allows for testing new-modified categories more easily and new models can easily be added for new categories. In case of issues, debugging and testing is also faster and isolated to the impacted categories.

Instead of being a single node that relies explicitly on the weights of a single model and a unified vocabulary to produce predictions, the LSTM architecture depicted in FIG. 7 is multi-nodal and uses N models (20 are depicted), each having its own specialized vocabulary and limited function(s). Although for any given product title it will use M0 702 for predicting.

At the 0th node M0 702, a token is generated. Based on this token, a decision is made at step 704 on whether to make a prediction right there for a subcategory at step 706 or to choose one of the subsequent nodes M1-M19 708 for prediction. Each node M0-M19 708 node represents a deep learning model, consisting of multiple simple neurons and LSTM (Long Short Term Memory) unit layers, containing millions of parameters, and specially designed, trained, and fine-tuned for their respective tasks. In FIG. 7, M0 node 702 predicts the department of the product.

If the M0 node 702 predicts that the department is supported by one of the other nodes M1-M19 708, it acts as a dispatcher to direct the product to the correct slave node M1-M19 708

M1-M19 nodes 708 are specifically designed for the purpose of predicting subcategories and consist of vocabularies specifically designed for the specific department. All slave nodes M1-M19 are models that are custom trained on the nuances of a specific subcategory (e.g., tires) and is only concerned with the prediction related to that specific subcategory.

For example, a new subcategory for tires can be added by adding a new slave node M (N) 708. Instead of having to retrain the entire subcategories node to include tires, the master node M0 702 instead would direct all products related to tires to the newly added slaved node. This avoids having to retrain the entire subcategory node to include tires or any other new subcategories. Such a design would also have the negative side effect of impacting the accuracy of other subcategories, not to mention the increased retraining time involving ˜40 million parameters.

In the LSTM architecture depicted in FIG. 7, the master node M0 702 will decide if a department is supported or not. In this case of tires, automotive would be the supported department and the subcategory slave node M (N) would be tires. Therefore, the scope of model retraining to add tires would include retraining the master node M0 702 to include Automotive as a department; and adding a new slave node 708, for example node M19 708 that will be trained on predicting tires.

This allows new subcategories to be supported by the LSTM architecture that does not involve retraining or impacting other subcategories and their accuracy. Further, this allows predictions to be made for any newly supported categories to be more accurate because they have a dedicated model. Testing the LSTM model is also simpler since quality assurance (QA) is only needed for the new node/model. This can reduce retraining time by ˜91% as the number of parameters needs to be retrained is reduced from ˜28.87 million to between 2.2 and 3.4 million.

While specific embodiments of the invention have been described above, it will be appreciated that the invention may be practiced other than as described. The embodiment(s) described, and references in the specification to “one embodiment,” “an embodiment,” “an example embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

1. A method for conducting a lease-purchase, the method comprising:
accessing a merchant website associated with a merchant by a consumer using an electronic device;
determining if the merchant is a supported retailer by a lease-purchase system,
wherein the lease-purchase system is independent of the merchant and the merchant website;
if the merchant is a supported retailer, transmitting a token to the electronic device for tracking items added to a virtual shopping cart by the consumer;
from a plurality of checkout options, selecting a first option to initiate the lease-purchase order for the consumer;
by the lease-purchase system, determining if the items in the virtual shopping cart qualify for the lease-purchase order;
for all qualifying items in the virtual shopping cart, redirecting the consumer to an application associated with the lease-purchase system to collect credit card information from the consumer;
determining, by the lease purchase system, if the consumer qualifies for the lease-purchase order based on the credit card information;
determining repayment terms and conditions for the consumer for the approved lease-purchase order; and
issuing the consumer a virtual credit card number to be used for checkout by the consumer at the merchant website.

2. The method according to claim 1, further comprising:
using the virtual credit card number, by the consumer, to purchase the items in the virtual shopping cart at the merchant website.

3. The method according to claim 1, wherein the virtual credit card number expires after a predetermined time period.

4. The method according to claim 1, wherein the virtual credit card number cannot be used at a website different than the merchant website.

5. The method according to claim 1, wherein the application associated with the lease-purchase system is a plug-in, an extension, a pop-up, or a redirect to a website associated with the lease-purchase system.

6. The method according to claim 1, further comprising:
by the lease-purchase system, charging the consumer for the lease-purchase order using the repayment terms and conditions.

7. The method according to claim 6, further comprising:
terminating the lease-purchase order if the items associated with the lease-purchase order are returned before expiration of the lease-purchase order.

8. The method according to claim 7, further comprising:
at the end of the lease-purchase order, offering the consumer sale of the items associated with the lease-purchase order.

9. A long-term short memory (LSTM) method for determining leasibility of products on a merchant website comprising:
scraping the merchant website to compile product data of a plurality of products;
tokenizing product titles from the product data;
at a primary node of an LSTM model, determining a category for each of the plurality of products based on the scraped product data;
based on the category determined for each of the plurality of products, processing the product data of the product by a slave node of a plurality of slave nodes of the LSTM model determined by the master node to determine a subcategory for the product,
wherein a subcategory associated with a first slave node does not overlap with a subcategory for a second slave node; and
dividing the plurality of products into a leasable products list and a non-leasable products list based on the outputs of the primary node and the plurality of slave nodes.

10. The method according to claim 9, further comprising;
after determining the category for each of the plurality of products, comparing the category to an approved predetermined list of categories;
wherein if the category is not on the approved predetermined list of categories, automatically adding the product to the non-leasable products list.

11. The method according to claim 9, further comprising:
adding a new subcategory to the plurality of slave nodes by retraining the master node with a category associated with the new subcategory and adding a new slave node to the plurality of slave nodes trained on product data associated exclusively with the new subcategory.
